(19) United States
(12) Patent Application Publication
(10) Pub. No.: US 2015/0305394 A1
(43) Pub. Date: Oct. 29, 2015

(54) EXTRUDED NUTRITIONAL POWDERS HAVING IMPROVED EMULSION STABILITY AND DISPERSIBILITY AND METHODS OF MANUFACTURING SAME

(71) Applicants: ABBOTT LABORATORIES, Abbott Park, IL (US); ABBOTT GMBH & CO. KG, Ludwigshafen (DE)

(72) Inventors: TERRENCE MAZER, New Albany, OH (US); THOMAS KESSLER, Schifferstadt (DE); NORMANELLA DEWILLE, Columbus, OH (US); DOUGLAS WEARLY, Blacklick, OH (US); YOUNGSUK HEO, Powell, OH (US); ULRICH WESTEDT, Schriesheim (DE); GARY KATZ, Columbus, OH (US); EIK-LANG LAU, Buffalo Grove, IL (US)

(73) Assignee: ABBOTT LABORATORIES, Abbott Park, IL (US)

(21) Appl. No.: 14/437,900

(22) PCT Filed: Oct. 24, 2013
(86) PCT No.: PCT/US2013/066680

§ 371 Date: Apr. 23, 2015

Related U.S. Application Data
(60) Provisional application No. 61/717,799, filed on Oct. 24, 2012.
(60) Provisional application No. 61/737,886, filed on Dec. 17, 2012.
(60) Provisional application No. 61/738,593, filed on Dec. 18, 2012.

(51) Int. Cl. A23L 2/395; A23L 1/29

(52) U.S. Cl. CPC A23L 2/395; A23L 1/296; A23V 2002/00

(57) ABSTRACT

Extruded nutritional powders and methods of manufacturing the extruded nutritional powders, including extruded infant nutritional powders and extruded adult nutritional powders are provided. The processes utilize an extruder that is capable of internally mixing and emulsifying protein, and optionally, a carbohydrate with fat and water into an emulsion that can be dried into a powder having equivalent fat separation and dispersibility as compared to spray dried powders.

### CROSS-REFERENCE TO RELATED APPLICATIONS

This application claims the benefit of U.S. Provisional Application Nos. 61/717,799, filed Oct. 24, 2012; 61/738,593, filed Dec. 18, 2012; and 61/737,886, filed Dec. 17, 2012; each of which is hereby incorporated by reference herein in its entirety.

### FIELD OF THE DISCLOSURE

The present disclosure relates to extruded nutritional powders having emulsion and dispersibility characteristics upon reconstitution similar to conventional spray dried nutritional powders. More particularly, the present disclosure relates to extruded nutritional powders and methods of manufacturing extruded nutritional powders, including infant nutritional powders and adult nutritional powders, by emulsifying the powder ingredients completely within the extruder during the manufacturing process.

### BACKGROUND OF THE DISCLOSURE

Powdered nutritional products, including total nutrition products such as powdered infant formulas, powdered follow on formulas, powdered pediatric formulas, and powdered adult nutritional products, are widely commercially available and their use has grown steadily over the years. These products typically contain at least one of a fat, a carbohydrate, and a protein, along with various vitamins and minerals, and potentially other nutritionally beneficial components. Prior to use, the powdered formula or product is reconstituted in water or another suitable liquid at a predetermined ratio to produce a ready-to-drink liquid. Such ready-to-drink liquids are typically consumed within about 24 hours of reconstitution.

Conventional spray dried powdered nutritional products, including both powdered infant formulas and powdered adult nutritional products, generally contain from about 0.5% to about 35% by weight fat component to provide the desired nutritional caloric density. In order for the finished powdered product to be package stable (i.e., not subject to significant oxidation and rancidity over its shelf life) and not have significant fat separation or creaming when reconstituted, during manufacturing the fat component is generally sheared to globules having a size of between about 0.1 and 20 microns, while simultaneously emulsifying the sheared fat globules with hydrated protein and other additional emulsifiers.

This shearing and emulsifying has traditionally been accomplished by preparing a high solids water slurry (i.e., 30% to 60% total solids) and pumping the slurry through a high pressure homogenizer with a homogenization pressure between 2000 and 4500 psig. The slurry is then typically evaporated to about 45% to 60% total solids and spray dried. This generally produces stable fat that is not subject to substantial oxidation during storage and is easily reconstituted.

Extrusion methods are known as highly efficient methods that significantly minimize the amount of water and energy needed and are capable of producing pellets that can be dried and ground into powdered material. But extrusion processes have generally not been used to date to produce powdered infant formulas and powdered adult nutritional products because of the inability of the extrusion process to produce a finished powder with a stable fat emulsion and with the dispersibility capabilities of conventional spray dried nutritional powders. Extruded nutritional powders have to date provided unwanted fat separation and creaming upon reconstitution, which leads to a less commercially desirable product. Additionally, extruded powders have also been unable to provide desirable dispersibility characteristics such that unwanted clumping and sticking is not an issue.

As such, there is a need in the art for efficient methods for producing extruded nutritional powders. It would be advantageous if the extruded nutritional powder resisted fat separation upon reconstitution and had improved dispersibility similar to spray dried nutritional powders.

### SUMMARY OF THE DISCLOSURE

The present disclosure is directed to extruded nutritional powders and processes for manufacturing extruded nutritional powders. The extruded powders typically contain protein, fat, and carbohydrate, and may optionally include vitamins, minerals, long chain polyunsaturated fatty acids, and the like. The high efficiency extrusion manufacturing processes described herein utilize an extruder that is capable of internally mixing and emulsifying protein, carbohydrate, or both, with fat and water into an emulsion that can be suitably extruded, dried, and milled into a powder having a desirable particle size distribution and water content. The extruded powders as described herein, upon reconstitution with conventional amounts of an aqueous solution, such as water, provide fat separation and dispersibility properties that are similar to, or even improved, as compared to conventional spray dried nutritional powders.

The present disclosure is further directed to a process for manufacturing an extruded nutritional powder. The process comprises introducing water into an extruder, introducing a dry blend comprising at least a portion of a protein and, optionally, a carbohydrate into the extruder, introducing an oil blend comprising a fat into the extruder, mixing the dry blend and oil blend to form an emulsified mixture within the extruder, and extruding the emulsified mixture to form an extrudate, drying the extrudate, and forming a powder from the dried extrudate. In some aspects, the process includes introducing protein, vitamins, minerals and amino acids, prior to mixing.

The present disclosure is further directed to a process for manufacturing an extruded nutritional powder. The process comprises introducing water into an extruder, introducing a dry blend comprising at least a portion of a protein and, optionally, a carbohydrate into the extruder and hydrating the dry blend, introducing an oil blend comprising a fat into the extruder, mixing the hydrated dry blend and oil blend to form an emulsified mixture within the extruder, wherein water comprises less than 22% by weight of total emulsified mixture, extruding the emulsified mixture to form an extrudate, drying the extrudate, and grinding the dried extrudate into a nutritional powder.

The present disclosure is further directed to a process for manufacturing an extruded nutritional powder. The process comprises introducing water into an extruder, introducing a protein into the extruder, introducing an oil blend comprising a fat into the extruder, introducing a carbohydrate into the extruder, mixing and emulsifying the protein, water, oil blend, and carbohydrate within the extruder to form an emulsified mixture, and extruding the emulsified mixture to form an extrudate, drying the extrudate, and grinding the dried extrudate into a nutritional powder. In some aspects, the process includes introducing a vitamin, mineral, amino acid, and active component (e.g., polyphenols, CaHMB, flavors, color) prior to mixing.

The present disclosure is further directed to an extruded powder comprising fat, carbohydrate, and protein, wherein the extruded powder, upon reconstitution with water, shows substantially no fat separation at 24 hours.

The present disclosure is further directed to an extruded powder comprising fat, carbohydrate, and protein, wherein the extruded powder, upon reconstitution with water, shows substantially no creaming defect at 24 hours.

The disclosure is further directed to methods for reducing the loss of a heat labile vitamin in a powdered nutritional product using the disclosed extrusion processes. The heat labile vitamins may include vitamin A, vitamin D, vitamin E, vitamin K, pantothenic acid, vitamin C, thiamine, folic acid, riboflavin, vitamin B12, biotin, and combinations thereof. The methods include the use of the disclosed extrusion methods to produce full nutrition products while avoiding the need for overfortification of the product.

It has been unexpectedly found that extruded nutritional powders having highly desirable properties and nutritional value can be prepared by forming an emulsified mixture of ingredients interior of an extruder; that is, the ingredients are introduced into an extruder at one or more times, areas, or both and then mixed and emulsified completely within the extruder such that there is no external emulsification required. The extruded nutritional powders, including infant formula powder, pediatric and follow-on powder, and adult nutritional powder, produced utilizing the extrusion methods described herein have good emulsion quality in that there is little to no fat separation upon reconstitution. Additionally, the powders have equivalent dispersibility as compared to conventional spray dried nutritional powders.

### BRIEF DESCRIPTION OF THE DRAWINGS

FIG. 1 is a schematic diagram of the extrusion process according to one embodiment of the present disclosure.

FIG. 2 is a schematic diagram of the extrusion process according to one embodiment of the present disclosure.

FIGS. 3A and 3B depict the fat separation of an extruded nutritional powder and a spray dried nutritional powder as analyzed in Example 1.

FIGS. 4A and 4B depict the dispersibility of an extruded nutritional powder and a spray dried nutritional powder as analyzed in Example 1.

### DETAILED DESCRIPTION OF THE DISCLOSURE

The extruded nutritional powders and corresponding manufacturing methods of preparing nutritional powders of the present disclosure are directed to powders made by utilizing an extruder apparatus to mix and emulsify all components internally; that is, the components are introduced into the extruder where they are mixed and emulsified completely within the extruder. The resulting nutritional powders of the present disclosure exhibit excellent emulsion and stability characteristics, and disperse well when reconstituted with water.

These and other elements or limitations of the extruded nutritional powders and methods of the present disclosure are described in detail hereinafter.

The term “nutritional powders” as used herein includes powdered infant nutritional formulas, adult nutritional powders, and nutritional powders generally.

The term “infant formula” as used herein includes both infant formulas, toddler formulas, and follow-on formulas wherein infant formulas are intended for infants up to 1 year of age and toddler and follow-on formulas are intended for children from 1 year of age to about 10 years of age.

The terms “adult nutritional powder” and “adult nutritional product” as used herein, are used interchangeably to refer to formulas for generally maintaining or improving the health of an adult, and include those formulas designed for adults who need to control their blood glucose.

The term “shelf life” as used herein refers to a product's commercially viable life-span, after which the product is unfit or undesirable for sale, consumption, or both.

References to process steps completed within the extruder (including, e.g., “complete,” “completely,” “completed,” “no external,” etc.) as used herein, refer to process steps that have been sufficiently completed within the extruder such that it is unnecessary to continue those process steps external to the extruder to produce the described nutritional products by the disclosed manufacturing process.

All percentages, parts and ratios as used herein, are by weight of the total formulation, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the extruded nutritional powders prepared using the processes of the present disclosure may also be substantially free of any optional or selected essential ingredient or feature described herein, provided that the remaining powder still contains all of the required ingredients or features as described herein. In this context, and unless otherwise specified, the term “substantially free” means that the selected powdered product contains less than a functional amount of the optional ingredient, typically less than 0.1% by weight, and also including zero percent by weight of such optional or selected essential ingredient.

The nutritional powders and corresponding manufacturing methods of the present disclosure can comprise, consist of, or consist essentially of the essential elements and limitations of the disclosure as described herein, as well as any additional or optional ingredients, components, or limitations described herein or otherwise useful in nutritional applications.

### Product Form

The nutritional products produced utilizing the extrusion processes as described herein are powdered nutritional products. The powdered nutritional products are typically in the form of flowable or substantially flowable particulate compositions. The compositions can easily be scooped and measured with a spoon or similar other device, and can easily be reconstituted to a ready-to-feed state by the intended user with a suitable aqueous liquid, typically water, to form a nutritional composition for immediate oral or enteral use. In this context, “immediate” use generally means within about 48 hours, most typically within about 24 hours, and ideally immediately after preparation, preferably right after reconstitution. Where the nutritional products are reconstituted in a ready-to-feed state, the reconstituted products preferably contain a stable emulsion.

The extruded nutritional powders of the present disclosure generally have a moisture content of from about 0.75% to about 5% by weight, including from about 2% to about 5% by weight, including from about 2% to about 4% by weight, including from about 2% to about 3% by weight, and including from about 2.5% to about 3% by weight. Final moisture content is chosen based upon the water activity of the dried powder that is designed to provide a microbiologically stable powder for a low acid product (pH>4.6), less than 0.86 aw water activity, preferably less than 0.5 aw water activity. The water activity should be measured for each composition.

Having a low moisture content allows the water activity to remain low, deterring the growth of microorganisms. This provides the extruded nutritional powder with a longer shelf life. Particularly, the powders of the present disclosure generally have a shelf life of at least 3 months, including at least 4 months, including at least 5 months, including at least 12 months, including at least 18 months, including at least 24 months, including at least 36 months, and including from about 6 to about 24 months.

The powders of the present disclosure may be formulated with sufficient kinds and amounts of nutrients so as to provide a sole, primary, or supplemental source of nutrition, or to provide a specialized nutritional formulation for use in individuals afflicted with specific diseases or conditions.

One specific product form includes an infant formula powder including a protein system that is substantially or even completely soy-based. Another specific product form includes an infant formula powder that is substantially or even completely lactose-free. Another specific product form includes an infant formula powder that includes rice starch. Another specific product form includes an infant formula powder that includes a protein system that is partially or even completely based on milk-based proteins. Another specific product form includes an infant formula powder that includes a protein system that is partially or even completely based on hydrolyzed proteins.

### Macronutrients

The extruded nutritional powders of the present disclosure comprise at least one of a fat, a protein, and a carbohydrate, and in many embodiments comprise fat, protein, and carbohydrate. Generally, any source of fat, protein, and carbohydrate that is known or otherwise suitable for use in powdered nutritional products may also be suitable for use in the extruded nutritional powders herein, provided that such macronutrients are also compatible with the essential elements of the nutritional compositions as defined herein.

Although total concentrations or amounts of the fat, protein, and carbohydrates may vary depending upon the nutritional needs of the intended user, such concentrations or amounts most typically fall within one of the following embodied ranges, inclusive of any other essential fat, protein, and or carbohydrate ingredients as described herein.

### Carbohydrate

The extruded nutritional powders of the present disclosure may comprise a carbohydrate source.

When the extruded nutritional powder is an infant nutritional powder, the carbohydrate component is present in an amount of from about 30% to about 85%, including from about 45% to about 60%, including from about 50% to about 55% by weight of the infant nutritional powder. The carbohydrate source may be any known or otherwise suitable source that is safe and effective for oral administration and is compatible with the essential and other ingredients in the powder.

When the extruded nutritional powder is an adult nutritional powder, the carbohydrate component is present in an amount of from about 5% to about 60%, including from about 7% to about 30%, including from about 10% to about 25%, by weight of the adult nutritional powder. The carbohydrate source may be any known or otherwise suitable source that is safe and effective for oral administration and is compatible with the essential and other ingredients in the powder.

Suitable carbohydrates or carbohydrate sources for use in the nutritional powders include glycerin, sucrose, dextrins in general and, specifically, maltodextrin, tapioca maltodexrin, corn syrup, tapioca syrup, isomaltulose, lactose, fructose, both unhydroyzed, partially hydrolyzed gums, gum Arabic, also known as gum acacia, xanthan gum, gum tragacanth, and guar gum, gellan gum, carrageenans, microcrystalline cellulose and carboxymethyl cellulose, glycerin, vegetable fibers, glucose, maltose, cooked and uncooked waxy and non-waxy corn starch, cooked and uncooked waxy and non-waxy tapioca starch, cooked and uncooked waxy and non-waxy rice starch, tagatose, galacto-oligosaccharides (GOS), fructo-oligosaccharides (FOS) including short chain, moderate length chain, and long chain fructo-oligosaccharides, alpha-lactose, beta-lactose, polydextrose, human milk oligosaccharides, and combinations thereof.

Other suitable carbohydrates include any dietary fiber or fiber source, non-limiting examples of which include insoluble dietary fiber sources such as oat hull fiber, pea hull fiber, soy hull fiber, soy cotyledon fiber, sugar beet fiber, cellulose, corn bran, and combinations thereof.

The carbohydrate for use in the extruded nutritional powder formulation may therefore include soluble and/or insoluble fiber, or other complex carbohydrate, preferably having a DE (dextrose equivalent) value of less than about 40, including less than 20, and also including from 1 to 10.

### Fat

The extruded nutritional powders of the present disclosure may comprise a fat or fat source.

When the extruded nutritional powder is an infant nutritional powder, the fat component is present in an amount of from about 10% to about 35%, including from about 25% to about 30%, and including from about 26% to about 28% by weight of the infant nutritional powder. The fat may be any known or otherwise suitable source that is safe and effective for oral administration and is compatible with the essential and other ingredients in the powder.

When the extruded nutritional powder is an adult nutritional powder, the fat component is present in an amount from about 0.5% to about 20%, including from about 1% to about 10%, and also including from about 2% to about 5% by weight of the adult nutritional powder. The fat may be any known or otherwise suitable source that is safe and effective for oral administration and is compatible with the essential and other ingredients in the powder.

Suitable fat or fat sources include coconut oil, soy oil, high oleic safflower or sunflower oil, safflower oil, sunflower oil, corn oil, palm oil, palm kernel oil, canola oil, triheptanoin, milk fat including butter, any animal fat or fraction thereof, fish or crustacean oils containing docosahexaenoic acid (DHA), eicosapentaenoic acid (EPA), or both, phospholipids from fish or crustacean containing docosahexaenoic acid (DHA), eicosapentaenoic acid (EPA), or both, concentrates of DHA, EPA, or both, from marine, vegetable, or fugal sources, arachidonic acid (ARA) concentrate from fungal or other sources, a-linolenic acid concentrate (ALA), flax seed oil, Borage oil or any other source of gamma linolenic acid (GLA), phospholipids and fractions thereof, including soy lecithin and egg lecithin, both partially hydrolyzed and unhydrolyzed, monoglycerides, diglycerides, or both, from both vegetable and animal sources, and plant sterols and compounds containing plant sterols, diacetyl tartaric acid of mono and diglycerides (DATEM) and combinations thereof.

### Protein

The extruded nutritional powders of the present disclosure may comprise a protein or protein source, and desirably a non-gelling protein or protein source.

When the extruded nutritional powder is an infant nutritional powder, the protein component is present in an amount of from about 5% to about 35%, including from about 8% to about 12%, and including from about 10% to about 12% by weight of the infant nutritional powder. The protein may be any known or otherwise suitable source that is safe and effective for oral administration and is compatible with the essential and other ingredients in the powder.

When the extruded nutritional product is an adult nutritional product, the protein component is present in an amount of from about 10% to about 90%, including from about 30% to about 80%, and also including from about 40% to about 75% by weight of the adult nutritional powder. The protein may be any known or otherwise suitable source that is safe and effective for oral administration and is compatible with the essential and other ingredients in the powder.

Suitable protein or protein sources include either intact, partially hydrolyzed, or fully hydrolyzed, or a combination thereof, of lactase treated nonfat dry milk, milk protein isolate, milk protein concentrate, whey protein concentrate, glycomacropeptides, whey protein isolate, milk caseinates such as sodium caseinate, calcium caseinate, or any combination of caseinate salts of any mineral, soy protein concentrate, soy protein isolate, soy protein flour, pea protein isolate, pea protein concentrate, any monocot or dicot protein isolate or protein concentrate, animal collagen, gelatin, all amino acids, taurine, milk protein peptides, whey protein peptides, bovine colostrum, human colostrum, other mammalian colostrum, genetic communication proteins found in colostrum and in mammalian milk such as, but not limited to, interleukin proteins, hydrolyzed animal collagen, hydrolyzed yeast, potato, rice, hydrolyzed rice, mycoproteins, wheat, canola, hydrolyzed canola, and combinations thereof.

### Macronutrient Profile

The total amount or concentration of fat, carbohydrate, and protein in the extruded nutritional powders of the present disclosure can vary considerably depending upon the selected formulation and dietary or medical needs of the intended user. Additional suitable examples of macronutrient concentrations are set forth below. In this context, the total amount or concentration refers to all fat, carbohydrate, and protein sources in the nutritional powder provided as a percentage of total weight of the nutritional powder. For infant nutritional powders, such total amounts or concentrations are most typically and preferably formulated within any of the embodied ranges described in the following table (all numbers have “about” in front of them).

| | Embodiment A | Embodiment B | Embodiment C |
|---|---|---|---|
| Nutrient | (% by weight) | (% by weight) | (% by weight) |
| Carbohydrate | 20-85 | 30-60 | 35-55 |
| Fat | 5-70 | 20-60 | 25-50 |
| Protein | 2-75 | 5-50 | 7-40 |

In other embodiments, where the infant nutritional powders contain heat labile vitamins, macronutrients amounts may be varied according to the following table.

Nutrients With Heat Labile Vitamins

| Nutrient | Range | gm/100 kcal | gm/liter |
|---|---|---|---|
| Carbohydrate | 1^{st} embodiment | 8-16 | 54-140 |
| | 2^{nd} embodiment | 9-13 | 61-88 |
| Fat | 1^{st} embodiment | 3-8 | 20-54 |
| | 2^{nd} embodiment | 4-6.6 | 27-45 |
| Protein | 1^{st} embodiment | 1-3.5 | 7-40 |
| | 2^{nd} embodiment | 1.5-3.4 | 10-23 |

¹All numerical values may be modified by the term “about”
²From ready-to-feed liquid, reconstituted powder, or diluted concentrate

For adult nutritional powders, such total amounts or concentrations are most typically and preferably formulated within any of the embodied ranges of the percentage of total weight as described in the following table (all numbers have “about” in front of them).

| | Embodiment A | Embodiment B | Embodiment C |
|---|---|---|---|
| Nutrient | (% by weight) | (% by weight) | (% by weight) |
| Carbohydrate | 1-98 | 10-75 | 30-50 |
| Fat | 1-98 | 20-85 | 35-55 |
| Protein | 1-98 | 5-70 | 15-35 |

### Optional Ingredients

The extruded nutritional powders of the present disclosure may further comprise other optional components that may modify the physical, chemical, aesthetic or processing characteristics of the powders or serve as pharmaceutical or additional nutritional components when used in the targeted population. Many such optional ingredients are known or otherwise suitable for use in medical food or other nutritional products or pharmaceutical dosage forms and may also be used in the powder formulations herein, provided that such optional ingredients are safe and effective for oral administration and are compatible with the essential and other ingredients in the powders.

Non-limiting examples of such optional ingredients include preservatives, anti-oxidants, emulsifying agents, buffers, pharmaceutical actives, additional nutrients as described herein, vitamins, minerals, sweeteners including artificial sweeteners (e.g., saccharine, aspartame, acesulfame K, Stevia extract, and sucralose) colorants, flavorants in addition to those described herein, thickening agents and stabilizers, emulsifying agents, lubricants, probiotics (such as acidophilus bifidus bacteria, or both, both alive and inactive), prebiotics, beta-hydroxy beta-methylbutyrate (HMB), green tea polyphenols, Beta alanine, arginine, and glutamine.

Non-limiting examples of suitable minerals for use herein include phosphorus, sodium, chloride, magnesium, manganese, iron, copper, zinc, iodine, calcium, potassium, chromium, molybdenum, selenium, and combinations thereof.

Non-limiting examples of suitable vitamins for use herein include carotenoids (e.g., beta-carotene, zeaxanthin, lutein, lycopene), biotin, choline, inositol, folic acid, pantothenic acid, choline, vitamin A, thiamine (vitamin B₁), riboflavin (vitamin B₂), niacin (vitamin B₃), pyridoxine (vitamin B₆), cyanocobalamine (vitamin B₁₂), ascorbic acid (vitamin C), vitamin D, vitamin E, vitamin K, and various salts, esters or other derivatives thereof, and combinations thereof. Any commercially acceptable form of vitamins these may be utilized.

In some embodiments, the vitamins used may include heat labile vitamins. Exemplary heat labile vitamins include vitamins A, D, E, C, K, pantothenic acid, thiamine, folic acid, riboflavin, vitamin B12, biotin, and combinations thereof, In particular embodiments, the heat labile vitamin may be selected from pantothenic acid, vitamin C, thiamine, folic acid, and a combination thereof.

Using the methods disclosed herein, at least about 80%, or at least about 85%, or at least about 90%, or at least about 95% of the heat labile vitamins may be retained in the nutritional compositions after processing via the extrusion process.

### Manufacture of Nutritional Powders Using Extrusion Process

The processes of the present disclosure incorporate the use of an extruder apparatus to provide extruded nutritional powders having similar physical properties to that of spray dried nutritional powders. In some embodiments of the manufacturing processes described herein, the extruder apparatus may utilize ultrasonic energy at one or more zones or elements of the process. In one desirable embodiment, ultrasonic energy may be applied to the extruder apparatus at the time of the formation of the emulsion in the interior of the extruder as described in detail herein. Ultrasonic energy may be particularly beneficial at those stages of the process where there is relatively low solids content and low viscosity.

Particularly, the extruded nutritional powders have similar dispersibility as compared to spray dried nutritional powders. The extruded nutritional powder completely dissolves when placed in room temperature water after a period of less than three minutes. The extruded nutritional powder completely dissolves when placed in water having a temperature of about 105° F. (40.6° C.) after a period of about 30 seconds. Powder dispersibility describes the degree of firmness and solubility of particles of gel, sediment, and creaming with a product. Dispersibility is evaluated using a visual evaluation with a scale of 1-6 that rates undissolved powder residue after reconstitution remaining on a 5 inch diameter 80 mesh screen. A score of 1 is a powder that dissolves completely with almost no residue and a score of 6 is a powder that does not dissolve well with significant residue. The method specifies the amount of powder to be added to 180 mL of 105 degree F. water, which is then placed in an eight ounce bottle with a lid and shaken moderately for 30 seconds. The contents of the bottle are then emptied into a 5 inch diameter 80 mesh screen. Several handfuls of tap water are then used to wash away foam through the screen to expose remaining undissolved particles or gel particles. A score of 1-4 is an acceptable powder dispersibility score. A score of 4 has approximately 25% of the 80 mesh screen with undissolved particles. A score of 5 or greater has approximately 40% or more of the screen with undissolved particles. A score of 5 or 6 is an unacceptable powder dispersibility score.

Additionally, the extruded nutritional powders have good emulsion stability in that there is little to no fat (oil) separation upon reconstitution. Surprisingly, the extruded nutritional powders have no fat separation after a period of at least 15 minutes, including at least 20 minutes, including at least 25 minutes, and including at least 30 minutes when placed in room temperature water. Further, the extruded nutritional powders have no fat separation after a period of at least 1 hour, including at least 3 hours, including at least 8 hours, including at least 10 hours, including at least 15 hours, including at least 20 hours, and including at least 24 hours when refrigerated at 1 degree C. to 4.5 degree C. Furthermore, in some embodiments, the extruded nutritional powders also maintain emulsion stability following reconstitution to a ready-to-feed form.

The extruder apparatus may be used to produce extruded powder in batch format, or in a continuous process. For preparing the mixture to be emulsified, the various components to be mixed and emulsified are typically added successively to the extruder. Any suitable extruder known for use in the nutritional art may be used with the processes of the present disclosure. The extruder may be a single screw, multi screw, ring screw, planetary gear extruder, and the like. In one particularly suitable embodiment, the extruded is a co-rotating, twin screw extruder that may be used to continuously process nutritional powders.

One embodiment of preparing the mixture to be extruded to form an extrudate includes initially introducing a dry blend into an extruder. The dry blend may include at least one or more of a protein (or portion of a protein component; that is, from 1% to 100% by weight of the protein component, desirably 22% to about 30% by weight) and optionally a carbohydrate as discussed herein, wherein the optional carbohydrate may optionally be lactose-free. In some embodiments, vitamins and minerals are optionally introduced with the dry blend. In other embodiments, the dry blend may include a protein and lactose preblend. The protein, or portion of the protein, may, in some embodiments, be dryblended with ingredients, such as citrates, that one skilled in the art based on the disclosure herein would know to aid in the hydration of proteins by complexing divalent minerals that interfere with solubility of the protein. In addition or in place of, a small amount of the total oil (such as 0.1% to about 3% by weight of the total oil, including about 1.4% by weight of the total oil) adequate to coat the outside of the powder particles, may also be introduced prior to water to aid in the protein hydration by slowing hydration of the outside of the particle and thereby allowing complete hydration of the total protein particle.

Water may then be introduced into the extruder to hydrate the dry blend. Water soluble vitamins and minerals may optionally be added at this hydration stage. Following hydration, emulsification is initiated by introducing an oil blend including fat and fat soluble vitamins along with fat soluble ingredients such as carotenoids into the extruder. Finally, dispersive mixing of any additional carbohydrates (also referred to as carbohydrate blend), water soluble vitamins and minerals, or additional optional liquid or dry components for use in the resulting extruded nutritional powders may be introduced simultaneously or successively into the extruder. The hydration, emulsification, and dispersive mixing steps of extrusion are entirely within the extruder. That is, there is no external emulsification of the components outside the extruder.

In alternative embodiments, water is added to the extruder prior to adding the dry blend to help ensure hydration of the powdered ingredients when added. Improved hydration allows the powdered ingredients to mix better so that they do not stick as readily to the inside of the extruder.

The processes of the present disclosure reduce the moisture levels of the components within the extruder from upwards of 37.5% by total weight of the components (e.g., dry blend, water, oil blend, etc.) to less than about 14% by total weight of the components. Typically, water comprises less than about 22% by weight of the total dry blend, water, oil blend and the like, including less than about 14% by weight of total dry blend, water, oil blend, and the like, including less than about 13.5% by weight, including less than about 13% by weight, including less than about 12% by weight, including less than about 11% by weight, including less than about 10% by weight, including less than about 9% by weight, including less than about 8% by weight, also including from about 6% by weight to about 14% by weight, including from about 7.5% by weight to about 13.2% by weight, and including from about 8% by weight to about 10% by weight of the total dry blend, water, oil blend, and the like.

Typically, the temperature of the mixing and emulsifying may be adjusted throughout the extruder dependent on the components to be added and the function of the work to be carried out. Typically, the temperatures of the mixing and emulsification process range from about 25° C. to about 100° C., including from about 55° C. to about 78° C., including from about 60° C. to about 70° C. In those embodiments where heat labile vitamins are used, the mixing and emulsification temperature may be slightly modified. In those embodiments, mixing and emulsification may be carried out at a temperature of from about 70° C. to about 100° C., or from about 80° C. to about 95° C., or at a temperature of about 90° C.

Additionally, the pressure may be adjusted accordingly from above atmospheric pressure (mixing and emulsification) up to between about 200 kPa and about 10 MPa (dispersive mixing, plasticizing, and extruding). Further, the components are mixed and emulsified within the extruder for a time period of about 30 seconds to about 300 seconds and including from about 55 seconds to about 180 seconds, including from about 75 seconds to about 120 seconds, and including from about 90 seconds to about 110 seconds. In those embodiments where heat labile vitamins are used, mixing and emulsification may occur for a period of about two minutes to about ten minutes, or from about three minutes to about eight minutes or about four minutes to about seven minutes, or about five minutes to about six minutes. In a particular embodiment, mixing and emulsification is carried out for about four minutes.

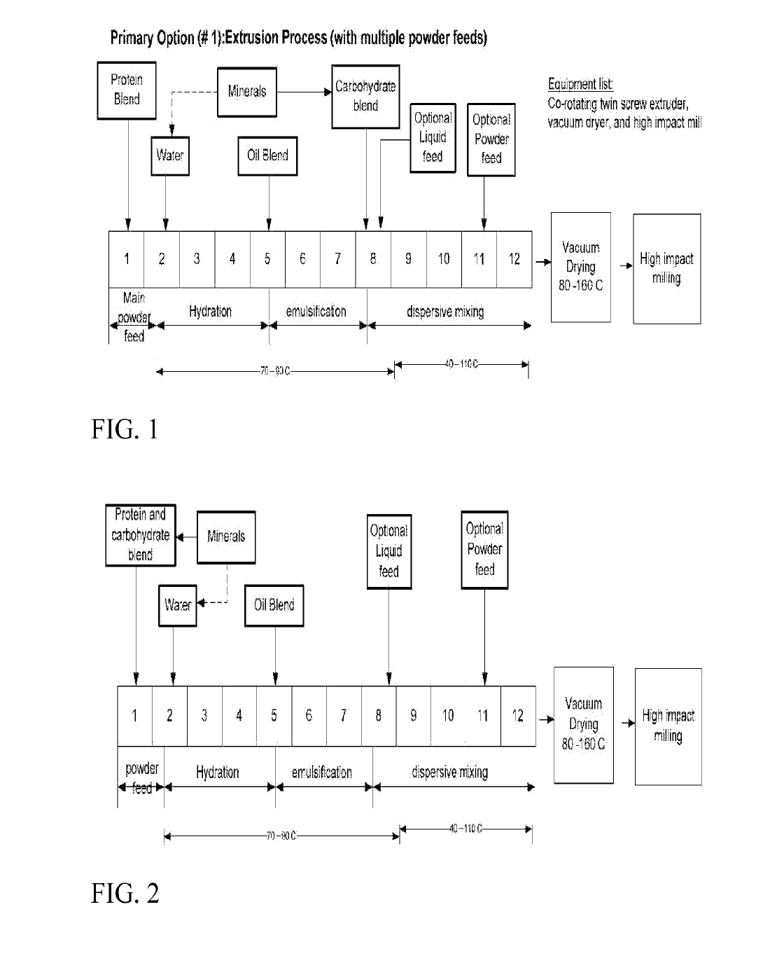

Referring now to FIG. 1, one suitable mixing and emulsifying process of the present disclosure includes an extruder having twelve different elements with multiple feed zones. One or more proteins are introduced into zone 1, water is introduced into zone 2 (start of hydration), the oil blend including oil soluble vitamins and oil soluble ingredients is introduced into zone 5 (start of emulsification), and finally the carbohydrates (e.g., lactose blend and galactooligosaccharides (GOS) and/or fructooligosaccharides (FOS)) are introduced into zone 8 (start of dispersive mixing). Optionally, water-soluble vitamins and minerals can be introduced in one or both of zones 2 and 8, optional liquid components may be introduced into zone 8, and optional dry powdered components may be introduced into zone 11. Temperatures in the zones of the extruder of this embodiment include: a temperature of about 80° C. in zones 1-7 and a temperature of about 60° C. in zones 8-12 with a total residence time in the extruder of from about 55 seconds to about 180 seconds.

The feed rates for the different components, as well as the flow rate for the final extruded mixture and sizes of the entry points to the different feed zones, are dependent on the size of the extruder.

Now referring to FIG. 2, another suitable embodiment of the mixing and emulsifying process of the present disclosure includes introducing a dry blend including at least a portion of a protein and optionally a portion of the carbohydrate into zone 1, water is introduced into zone 2 (start of hydration), and the oil blend including the oil soluble vitamins and oil soluble ingredients is introduced into zone 5 (start of emulsification). Optionally, water-soluble vitamins and minerals can be introduced in one or both of zones 1 and 2, optional liquid components may be introduced into zone 8 (start of dispersive mixing), and optional dry powdered components may be introduced into zone 11.

Once the components are mixed and emulsified as described herein, the emulsified mixture is extruded from the extruder and dried. In some optional embodiments, the extrudate may be cut into desired sizes upon exiting the extruder. The emulsified mixture may be extruded as a cake, or may optionally be extruded through a die, which may potentially reduce the amount of shear that the finished product is exposed to. The shear applied at any time during the manufacturing process, and suitable during the emulsification process, may be continuous shear or non-continuous shear.

Numerous conventional drying means are suitable for drying the extrudate to the desired water content of the final product. For example, the extrudate may be dried using a vacuum belt dryer, a continuous microwave dryer, or a vacuum drum dryer. Other drying processes, including infrared drying or spray drying may also be used in some embodiments to produce a suitably dry extruded nutritional powder. Typically, the extrudate is dried at a temperature of from about 80° C. to about 160° C., including from about 90° C. to about 150° C., and including from about 105° C. to about 130° C. Drying including microwave drying, radiant drying, and conduction drying may suitably be used.

An exemplary vacuum belt dryer is the Merk Vacuum belt dryer which includes an infrared component and a direct contact heater. Where used, the amount of drying time will depend on the amount of water added to the extruder. For example, about 1.0 to about 1.6 kg/hr of water may require about 5 to about 45 minutes of drying time, such as about 25 minutes. The vacuum pressure may be about 20 to about 50 mbar, such as about 30 mbar. The vacuum drying temperature may be about 100° C. to about 170° C.

Alternatively, the extrudate may be dried by subjecting it to radiation via a continuous microwave dryer. The extruded material may be transported through the microwave dryer via a conveyor passing through the microwave dryer. The conveyor may deposit the extruded material across the conveyor at a uniform density and a uniform thickness for uniform product characteristics. The desired depth of the product may vary depending on the penetration depth of the microwave emitter.

The microwave dryer may use air flow in the interior of the microwave dryer to further aid in drying the wet extrudate. The air flow may be heated, dried, or both, prior to entering the microwave dryer, or the air may be ambient air as it exists near the process site. For instance, the wet extrudate may be dried in the microwave dryer for a period of about 5 to about 20 minutes. The microwave dryer may have a vacuum pressure of about 20 mbar to about 30 mbar and a power of about 0.3 to about 1.0 KW.

Alternatively, the extrudate may be dried using a vacuum drum dryer. The drum dryer may include a pair of drums positioned substantially parallel with each other. Although the present example includes two drums, any other suitable number of drums may be used. The drums may be spaced apart to form gap distance about 0.1 mm to about 2 mm between the drums. The drums may rotate in opposing directions. The drums may be made of carbon or stainless steel and coated in a hard chrome-plated metal. The drums may be positioned within a housing.

The wet extrudate may be distributed between the drums such that the extrudate is adhered to the drums as the extrudate passes through the gap between the drums. The extrudate may be applied such that the extrudate is distributed substantially evenly onto the drums. The wet extrudate may be fed from above the drums such that the extrudate is fed through the drums by gravity. Alternatively, a belt system or other suitable system may be used to feed the extrudate through the drums.

The drums may be heated, such as with steam or thermal oil, to dry the wet extrudate applied to the drums. As the extrudate is applied to and rotates on the heated drums, the moisture content of the extrudate evaporates. A scrapper may be positioned adjacent to each drum such that the scrappers remove the extrudate adhered to the drum as the drum rotates against the scrapper. The scrappers may be positioned about 270 degrees around the circumference of the drum from the entry point of the extrudate such that the extrudate is applied to the drums for about a ¾ turn. For instance, the drums may rotate between about 0.5 to about 3 rpm, such as about 2 rpm. The wet extrudate may be dried in the drum dryer for a period of about 15 to about 90 seconds at a temperature of about 90° C. to about 140° C. The rotary drum dryer may have a vacuum pressure of about 50 mbar.

In one particularly suitable embodiment, the dried extrudate includes water in an amount of no more than about 5% by weight. The extrudate may be dried to a water content of from about 0.5% by weight to about 5% by weight, including from about 0.75% by weight to about 5% by weight, including from about 2% by weight to about 4% by weight, including about 2% by weight to about 3% by weight, and including about 2.5% by weight to about 3% by weight.

In some embodiments, after the emulsified mixture is sufficiently dried to the desired water level, one or more optional encapsulated ingredients may further be added to the dried emulsified mixture via dryblending or drymixing. Dryblending or drymixing procedures are known in the art and include the addition of one or more dry or substantially dry ingredients to a dried base powder, such as a dried extruded base nutritional powder. These optional ingredients include proteins, carbohydrates, vitamins, minerals, long chain polyunsaturated acids such as DHA, ARA, and/or EPA, flavors, nucleotides, nucleosides and other optional ingredients as discussed herein. In one specific embodiment, the dryblended ingredients are substantially or completely lactose-free.

Finally, the dried emulsified mixture may be ground into an extruded nutritional powder having a desired particle size. Dryblending or drymixing may also be applied to the ground nutritional powder, i.e., dryblending may occur subsequent to grinding the dried extrudate to the nutritional powder or forming the nutritional powder from the dried extrudate. Typically, the mixture is ground using high impact milling, although other conventional grinding methodologies may suitably be used in accordance with the present disclosure. The granules of the extruded nutritional powder may have a bulk density of from about 400 g/1 to about 700 g/1 with a particle size range of 100-300 microns, preferably 100-250 microns, most preferably 100-225 microns. The extruded nutritional powders may be an extruded infant nutritional powder, an extruded pediatric nutritional powder, an extruded follow on formula nutritional powder, or may be an extruded adult nutritional powder.

As noted above, the extruded nutritional powders of the present disclosure manufactured by the extrusion processes described herein provide fat separation (emulsion quality) and dispersibility in water that is at least equivalent to conventional spray dried nutritional powders; that is, the extruded powders of the present disclosure have excellent emulsification properties such that upon reconstitution with a conventional amount of water, the resulting liquid mixture is substantially stable and there is substantially no fat (oil) separation in the product over an extended period of time, even up to 24 hours or longer under refrigerated temperatures, typically −3 degrees C. to about 5 degrees C. Additionally, the extruded nutritional powders show excellent dispersibility upon mixing with water such that clumping is substantially reduced or eliminated. The extruded nutritional powder thus provides reconstituted liquids that have substantially no creaming defects over time, including at 24 hours under refrigerated temperature, typically −3 degrees C. to about 5 degrees C.

The present embodiments are to be considered in all respects as illustrative and not restrictive and that all changes and equivalents also come within the description of the present disclosure. The following non-limiting examples will further illustrate the extruded nutritional powders and methods of the present disclosure.

### EXAMPLES

The following examples illustrate specific embodiments and/or features of the extruded nutritional powders of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the powder, unless otherwise specified.

### Example 1

In this Example, an extruded nutritional powder was prepared using the process set forth in FIG. 1. The water rate utilized was 1.6 kg/hour and the extrudate rate was 10 kg/hour. The extruded nutritional powder was prepared using the bill of materials of Example 3.

The emulsion quality and dispersibility of the extruded nutritional powder upon reconstitution with water was analyzed and compared to a spray dried nutritional powder having the same composition.

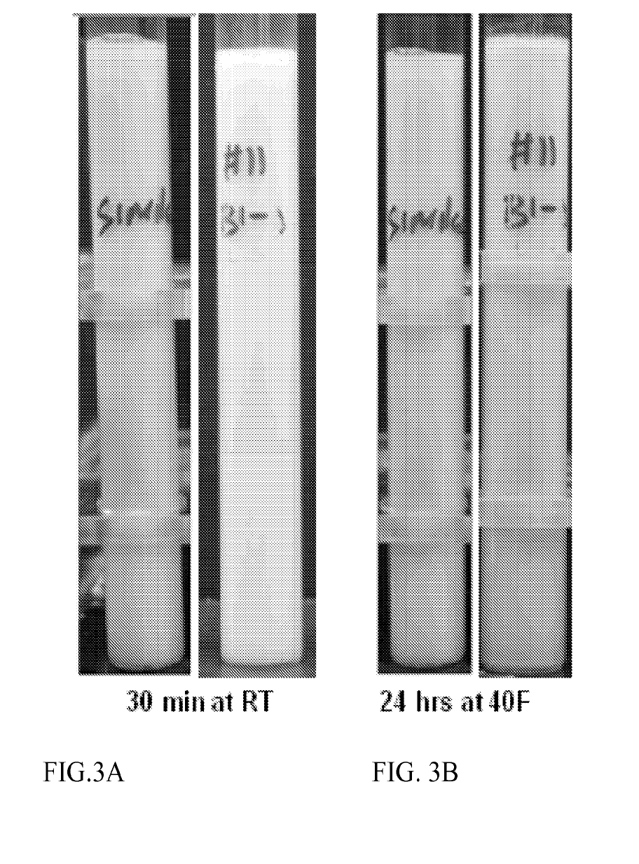

The emulsion quality was analyzed by evaluating the fat separation for both the extruded nutritional powder and the spray dried nutritional powder at room temperature 30 minutes after reconstitution and at 40° F. (4.4° C.) 24 hours after reconstitution. The results are shown in FIGS. 3A and 3B.

As shown in FIGS. 3A and 3B there was little to no fat separation at either time point of 30 minutes or 24 hours after reconstitution. That is, the emulsion quality with respect to fat separation was similar for the extruded nutritional powder and the spray dried nutritional powder.

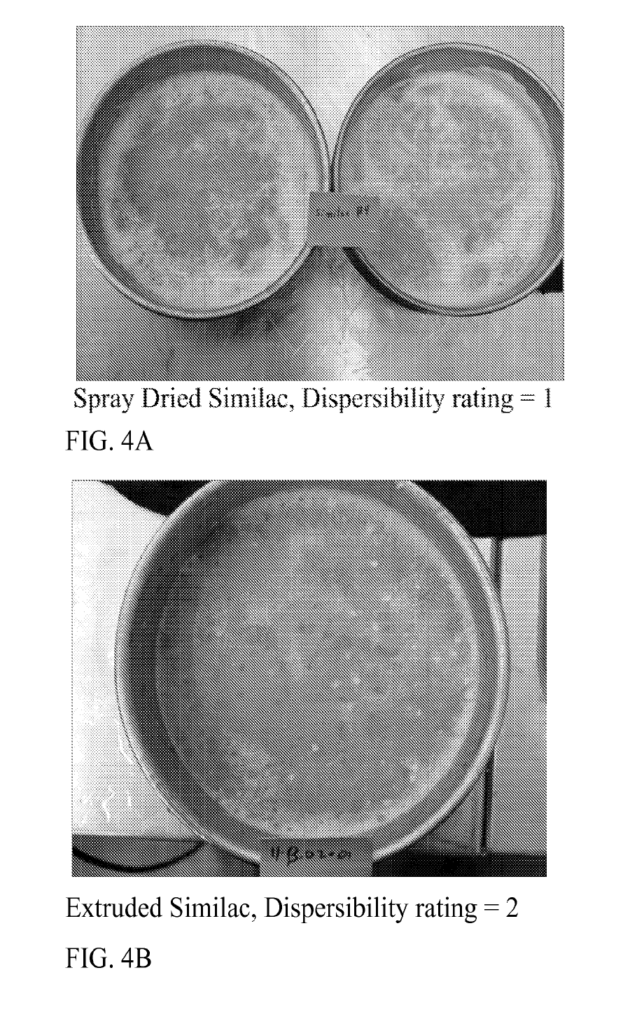

Additionally, the dispersibility of the extruded nutritional powder was compared to the dispersibility of the spray dried nutritional powder. The results are shown in FIGS. 4A and 4B. As shown in FIGS. 4A and 4B, dispersion of the extruded nutritional powder was similar to the spray dried nutritional powder.

### Example 2

Example 2 illustrates a pediatric nutritional powder that could be prepared using the extrusion methods of the present disclosure. The starting ingredients of Example 2 are listed in the following Table.

| | Amount per | |
|---|---|---|
| Ingredients | 50,000 lbs | |
| Com Syrup | 17,269 | lbs |
| Sucrose | 11,021 | lbs |
| Milk Protein Isolate | 6,756 | lbs |
| High Oleic Safflower Oil | 5,810 | lbs |
| Coconut Oil | 4,060 | lbs |
| Soy Oil | 4,110 | lbs |
| Galacto-Oligosaccharides (GOS) | 2,213 | lbs |
| Tricalcium Phosphate | 95.4 | kg |
| Potassium Citrate Tribasic, Monohydrate | 126 | kg |
| Potassium Chloride | 196 | kg |
| Magnesium Chloride, hexahydrate | 2.40 | kg |
| Sodium Citrate Tribasic, dehydrate | 180 | kg |
| Magnesium Phosphate Dibasic, trihydrate | 37.1 | kg |
| Calcium Phosphate Dibasic, anhydrous | 60.6 | kg |
| Calcium Carbonate, anhydrous | 3.42 | kg |
| Ascorbic Acid | 36.1 | kg |
| Water Soluble/Vitamin/Trace Mineral/Taurine Premix | 32.5 | kg |
| Ferrous Sulfate, heptahydrate | 10.3 | kg |
| Oil Soluble Vitamin Premix | 7.96 | kg |
| Nucleotide/Choline Premix | 59.4 | kg |
| Ascorbyl Palmitate | 19.5 | kg |
| Mixed Tocopherols | 3.59 | kg |
| L-Carnitine | 2.45 | kg |
| Choline Chloride | 20.6 | kg |
| Vitamin A Palmitate | 0.183 | kg |
| Riboflavin | 0.123 | kg |
| Potassium Iodide | 0.0339 | kg |
| ARA oil | 66.7 | kg |
| DHA oil | 24.0 | kg |
| Mixed Carotenoid Premix | 4.25 | kg |
| Potassium Hydroxide (Solids) | 26 | kg |

### Example 3

Example 3 illustrates an infant nutritional powder that could be prepared using the extrusion methods of the present disclosure. The starting ingredients of Example 3 are listed in the following Table.

| | Amount per | |
|---|---|---|
| Ingredients | 50,000 lbs | |
| Non-Fat Milk Solids | 10,221 | lbs |
| Lactose | 19,201 | lbs |
| Whey Protein Concentrate | 2,545 | lbs |
| High Oleic Safflower Oil | 5,910 | lbs |
| Coconut Oil | 4,126 | lbs |
| Soy Oil | 4,181 | lbs |
| Galactooligosaccharides | 3,365 | lbs |
| ARA oil | 64.9 | kg |
| DHA oil | 24.7 | kg |
| Potassium Citrate Tribasic, monohydrate | 203 | kg |
| Magnesium Chloride, hexahydrate | 21.5 | kg |
| Ascorbic Acid | 28.9 | kg |
| Water Soluble Vitamin/Trace Mineral/Taurine Premix | 25.3 | kg |
| Ferrous Sulfate, heptahydrate | 10.7 | kg |
| Oil Soluble Vitamin Premix | 8.26 | kg |
| Ascorbyl Palmitate | 8.28 | kg |
| Mixed Tocopherols | 3.66 | kg |
| Nucleotide/Choline Premix | 54.4 | kg |
| Calcium Carbonate, anhydrous | 99.3 | kg |
| Choline Chloride | 9.80 | kg |
| Potassium Chloride | 28.3 | kg |
| L-Carnitine | 0.597 | kg |
| Soy Lecithin | 25.4 | kg |
| Sodium Chloride | 7.88 | kg |
| Riboflavin | 0.0722 | kg |
| Mixed Carotenoid Premix | 4.25 | kg |
| Tricalcium Phosphate | 0-10 | kg |
| Potassium Phosphate Monobasic, anhydrous | 0-10 | kg |
| Potassium Hydroxide (Solids) | 11 | kg |

### Example 4

Example 4 illustrates an infant nutritional powder that could be prepared using the extrusion methods of the present disclosure. The starting ingredients of Example 4 are listed in the following Table.

| | Amount per | |
|---|---|---|
| Ingredients | 50,000 lbs | |
| Com Syrup | 25,390 | lbs |
| Sucrose | 4,951 | lbs |
| Soy Protein Isolate | 7,325 | lbs |
| High Oleic Safflower Oil | 5,733 | lbs |
| Coconut Oil | 3,865 | lbs |
| Soy Oil | 4,194 | lbs |
| Fructooligosaccharides | 368 | kg |
| Tricalcium Phosphate | 264 | kg |
| Potassium Citrate Tribasic, monohydrate | 349 | kg |
| Potassium Chloride | 2.95 | kg |
| Magnesium Chloride, hexahydrate | 58.9 | kg |
| Sodium Chloride | 76.4 | kg |
| L-Methionine | 38.0 | kg |
| Ascorbic Acid | 36.1 | kg |
| Choline Chloride | 11.5 | kg |
| Water Soluble Vitamin/Trace Mineral/Taurine Premix | 32.5 | kg |
| Ferrous Sulfate, heptahydrate | 6.92 | kg |
| Oil Soluble Vitamin Premix | 8.45 | kg |
| Mixed Carotenoid Premix | 4.25 | kg |
| Ascorbyl Palmitate | 8.11 | kg |
| Mixed Tocopherols | 3.57 | kg |
| L-Carnitine | 2.45 | kg |
| Potassium Iodide | 0.0229 | kg |
| Calcium Phosphate Dibasic, anhydrous | 155 | kg |
| ARA oil | 64.9 | kg |
| DHA oil | 24.7 | kg |
| Potassium Hydroxide (Solids) | 30 | kg |

### Example 5

Example 5 illustrates an adult nutritional powder that could be prepared using the extrusion methods of the present disclosure. The starting ingredients of Example 5 are listed in the following Table.

| Ingredients | Amount per 1000 KG | |
|---|---|---|
| Calcium caseinate | 239.3 | kg |
| Maltodextrin | 235.7 | kg |
| High oleic sunflower oil | 147.4 | kg |
| Fructose | 121.6 | kg |
| Maltitol powder | 104.9 | kg |
| Maltodextrin | 42.8 | kg |
| Soy fiber, | 23.3 | kg |
| Oligofructose | 19.1 | kg |
| Magnesium sulfate | 19.0 | kg |
| Sodium phosphate dibasic dihydrate | 11.3 | kg |
| Soy oil | 11.1 | kg |
| Potassium chloride | 10.5 | kg |
| Vanilla flavoring agent | 10.3 | kg |
| Sodium phosphate monobasic monohydrate | 5.9 | kg |
| Calcium carbonate | 5.0 | kg |
| m-inositol | 4.4 | kg |
| Potassium hydroxide | 3.6 | kg |
| Choline chloride | 2.8 | kg |
| Sodium ascorbate | 2.0 | kg |
| Magnesium phosphate dibasic | 1.9 | kg |
| Sodium chloride | 1.8 | kg |
| l-carnitine | 1.2 | kg |
| Acesulfame K | 750.0 | g |
| Ferrous sulfate | 495.2 | g |
| Taurine | 449.2 | g |
| dl-alpha tocopheryl acetate | 439.2 | g |
| Vitamin A, D³, E, K₁ premix | 379.6 | g |
| Zinc sulfate | 346.8 | kg |
| Vitamin Premix | 290.5 | kg |
| Ascorbyl palmitate | 185.2 | g |
| Manganese sulfate | 62.1 | g |
| Tocopherol | 61.7 | g |
| Copper sulfate | 57.5 | g |
| Beta carotene | 30.3 | g |
| Chromium potassium sulfate dodecahydrate | 24.9 | g |
| Pyridoxine hydrochloride | 13.2 | g |
| Folic acid | 2.1 | g |
| Sodium molybdate | 2.0 | g |
| Potassium iodide | 1.1 | g |
| Sodium selenite | 880.5 | mg |
| Cyanocobalamin | 32.0 | mg |

| | |
|---|---|
| Citric acid | As needed |
| Water | As needed |

### Example 6

Example 6 illustrates an infant nutritional powder that could be prepared using the extrusion methods of the present disclosure. The starting ingredients of Example 5 are listed in the following Table.

| Ingredients | Amount per 1000 KG | |
|---|---|---|
| Skim milk | 486 | |
| Organic high oleic sunflower oil | 96.5 | |
| Organic coconut oil | 70.7 | |
| Organic soy oil | 68.3 | |
| Maltodextrin | 128.6 | |
| Sucrose | 99.1 | |
| Galactooligosaccharide | 68.2 | |
| Calcium carbonate | 4.3 | |
| Ascorbic acid | 2.0 | |
| Potassium citrate | 1.8 | |
| Nucleotide choline premix | 1.8 | |
| Sodium citrate | 1.6 | |
| Lecithin | 1.5 | |
| Potassium phosphate dibasic | 947.4 | g |
| Mixed carotenoids | 938.1 | g |
| Docosahexaenoic acid | 740.5 | g |
| Vitamin/trace mineral premix | 613.4 | g |
| Sodium chloride | 461.4 | g |
| Vitamin ADEK premix | 319.5 | g |
| Ascorbyl palmitate | 306.1 | g |
| Ferrous sulfate | 297.3 | g |
| Arachidonic acid | 233.8 | g |
| Tocopherol-2 | 134.7 | g |
| Potassium iodide | 401.6 | mg |
| Manganese sulfate | 123.9 | mg |

| | |
|---|---|
| Magnesium chloride | As needed |
| Choline chloride | As needed |
| Sodium selenite | As needed |
| Citric acid | As needed |
| Potassium hydroxide | As needed |
| Water | q.s. |
| Natural Vanilla Extract | 8.0 |
| Lactic acid Bifidobacterium culture | 1.0 |

### Example 7

Example 7 illustrates an infant nutritional powder prepared with heat labile vitamins.

| | Amount |
|---|---|
| Ingredient Description | kg/1,000 kg |
| NFDM | 199 |
| WPC | 60.3 |
| Lactose | 376 |
| Potassium Citrate | 8.05 |
| Calcium Carbonate | 4.18 |
| Nucleotide/Choline Premix | 2.29 |
| Potassium Chloride | 1.52 |
| Sodium Ascorbate | 1.44 |
| Vitamin/Mineral Premix | 1.09 |
| Magnesium Chloride | 0.874 |
| Sodium Chloride | 0.781 |
| Ferrous Sulfate | 0.442 |
| Choline Chloride | 0.421 |
| L-Carnitine | 0.0256 |
| Riboflavin | 0.00310 |
| Water | 101-162 |
| HOSO (High Oleic | 112 |
| Saflower Oil) | |
| Soy Oil | 83.5 |
| Coconut Oil | 76.9 |
| ARA | 2.87 |
| Lecithin Ultralec | 1.10 |
| DHA | 1.08 |
| Vitamin ADEK | 0.368 |
| MC Premix | 0.182 |
| Beta Carotine | 0.000598 |
| GOS | 65.5 |

The ingredients listed above are extruded to form a nutritional composition. The protein and lactose blends are introduced into the extruder via a hopper. Water is added into the extruder to perform hydration. After the composition has been hydrated, the oil blend is introduced into the extruder. Once the oil blend is introduced, the composition within the extruder is emulsified (i.e., the composition is emulsified within the extruder). After emulsification, galactooligosaccharides (GOS) are introduced into the extruder, wherein dispersive mixing is performed.

After the extrusion step, the extrudate is dried in a Merk Vacuum belt dryer for about 25 minutes of drying time. The dried extrudate product contains less than about 5% moisture content. Once dried, the extrudate is milled using a Fitzmill to obtain granules in the range of from about 275 to about 325 microns.

1.-43. (canceled)

44. A process for manufacturing an extruded nutritional powder, the process comprising:
introducing water into an extruder;
introducing a dry blend comprising at least a portion of a protein and, optionally, a portion of a carbohydrate into the extruder;
introducing an oil blend comprising fat into the extruder;
mixing the dry blend and oil blend to form an emulsified mixture within the extruder and extruding the emulsified mixture to form an extrudate;
drying the extrudate; and
forming a powder from the dried extrudate.

45. The process of claim 44 wherein the dry blend, water, and oil blend are held within the extruder for a total time period of from about 30 seconds to about 300 seconds.

46. The process of claim 44 further comprising dryblending at least one ingredient with the dried extrudate subsequent to forming a powder from the dried extrudate.

47. The process of claim 46 wherein the at least one ingredient is selected from the group consisting of probiotics, encapsulated PUFAs, and combinations thereof.

48. The process of claim 44 wherein the extruder is a co-rotating twin screw extruder.

49. The process of claim 44 wherein the drying is done using a vacuum belt dryer, a vacuum drum dryer, or a continuous microwave dryer.

50. The process of claim 44 wherein the extruded nutritional powder is selected from the group consisting of a soy based-extruded nutritional powder, a lactose-free extruded nutritional powder, a rice-starch based extruded nutritional powder, a milk protein-based extruded nutritional powder, a protein hydrolysate-based extruded nutritional powder, and combinations thereof.

51. The process of claim 44 wherein water comprises less than 22% by weight of total dry blend, water, and oil blend.

52. The process of claim 44 wherein the dry blend comprises protein and carbohydrate.

53. The process of claim 44 wherein the dry blend further comprises vitamins, minerals, or both.

54. The process of claim 44 wherein the dry blend, water, and oil blend are mixed and emulsified at a temperature range of from about 25° C. to about 100° C.

55. The process of claim 44 comprising drying the extrudate at a temperature of from about 80° C. to about 160° C.

56. The process of claim 44 wherein the extrudate is dried to a moisture content of between about 0.75% to about 5%.

57. The process of claim 44 wherein the extrudate is dried for a period of about 5 minutes to about 45 minutes using a vacuum belt dryer to produce a nutritional composition, wherein said nutritional composition forms a stable emulsion upon reconstitution.

58. The process of claim 44, wherein the drying step is performed at a pressure of about 20 mbar to about 50 mbar.

59. The process of claim 44, wherein the drying step is performed at a temperature of about 100° C. to about 170° C.

60. An extruded powder comprising at least one of a fat, protein, and carbohydrate, and at least one vitamin, mineral, or other nutrient, or combination thereof, made according to the process of claim 54.

61. The extruded powder of claim 60 wherein the extruded powder is dried using a vacuum belt dryer for a period of about 25 minutes, at a pressure of about 20 mbar to about 50 mbar, and at a temperature of about 100° C. to about 170° C.

62. The extruded powder of claim 60 comprising fat, carbohydrate, and protein, wherein the extruded powder, upon reconstitution with water, shows substantially no fat separation at 24 hours.

63. The extruded powder of claim 60 comprising fat, carbohydrate, and protein, wherein the extruded powder, upon reconstitution with water, shows substantially no creaming defect at 24 hours.
